(19) United States
(12) Patent Application Publication
(10) Pub. No.: US 2010/0024001 A1
(43) Pub. Date: Jan. 28, 2010

(54) Securing Blade Servers In A Data Center

(75) Inventors: Keith M. Campbell, Cary, NC (US); Rajiv N. Kantesaia, Cary, NJ (US); Caroline M. Metry, Cary, NC (US); Michael N. Womack, Raleigh, NC (US)

Correspondence Address: IBM (RPS-BLF);c/o BIGGERS & OHANIAN, LLP, P.O. BOX 1469, AUSTIN, TX, 78767-1469, US

(73) Assignee: INTERNATIONAL BUSINESS MACHINES CORPORATION, Armonk, NY (US)

(21) Appl. No.: 12/179,910

(22) Filed: Jul. 25, 2008

(51) Int. Cl. G06F 7/04

(52) U.S. Cl. 726/2

(57) ABSTRACT

Securing blade servers in a data center, the data center including a plurality of blade servers installed in a plurality of blade server chassis, the blade servers and chassis connected for data communications to a management module, each blade server chassis including a chassis key, where securing blade servers includes: prior to enabling user-level operation of the blade server, receiving, by a security module, from the management module, a chassis key for the blade server chassis in which the blade server is installed; determining, by the security module, whether the chassis key matches a security key stored on the blade server; if the chassis key matches the security key, enabling, by the security module, user-level operation of the blade server; and if the chassis key does not match the security key, disabling, by the security module, operation of the blade server.

### BACKGROUND OF THE INVENTION

1. Field of the Invention

The field of the invention is data processing, or, more specifically, methods, apparatus, and products for securing blade servers in a data center.

2. Description of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

Some computing systems today are configured as blade servers having relatively small form factors and installed in blade server chassis. Due to their small form factor, blade servers may be easily moved from one chassis to another in, or even outside, a data center. Moving a blade server as such may increase security risks in an organization. Currently, however, there is no known method to prevent blades from powering-on in an unauthorized or restricted blade server chassis.

### SUMMARY OF THE INVENTION

Methods, apparatus, and products for securing blade servers in a data center, the data center including a plurality of blade servers, each blade server installed in one of a plurality of blade server chassis, the blade servers and the blade server chassis connected for data communications to a management module, each blade server chassis including a chassis key stored in non-volatile memory of the chassis. Securing blade servers according to embodiments of the present invention includes: upon receiving power in a blade server installed in one of the blade server chassis and prior to enabling user-level operation of the blade server, receiving, by a security module, from the management module, a chassis key for the blade server chassis in which the blade server is installed; determining, by the security module, whether the chassis key matches a security key stored on the blade server; if the chassis key matches the security key, enabling, by the security module, user-level operation of the blade server; and if the chassis key does not match the security key, disabling, by the security module, operation of the blade server.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a functional block diagram of an exemplary implementing blade server security in a data center according to embodiments of the present invention.

FIG. 2 sets forth a flow chart illustrating an exemplary method for securing blade servers in a data center according to embodiments of the present invention.

FIG. 3 sets forth a flow chart illustrating a further exemplary method for securing blade servers in a data center according to embodiments of the present invention.

FIG. 4 sets forth a flow chart illustrating a further exemplary method for securing blade servers in a data center according to embodiments of the present invention.

FIG. 5 sets forth a flow chart illustrating a further exemplary method for securing blade servers in a data center according to embodiments of the present invention.

FIG. 6 sets forth a flow chart illustrating a further exemplary method for securing blade servers in a data center according to embodiments of the present invention.

### DETAILED DESCRIPTION OF EXEMPLARY EMBODIMENTS

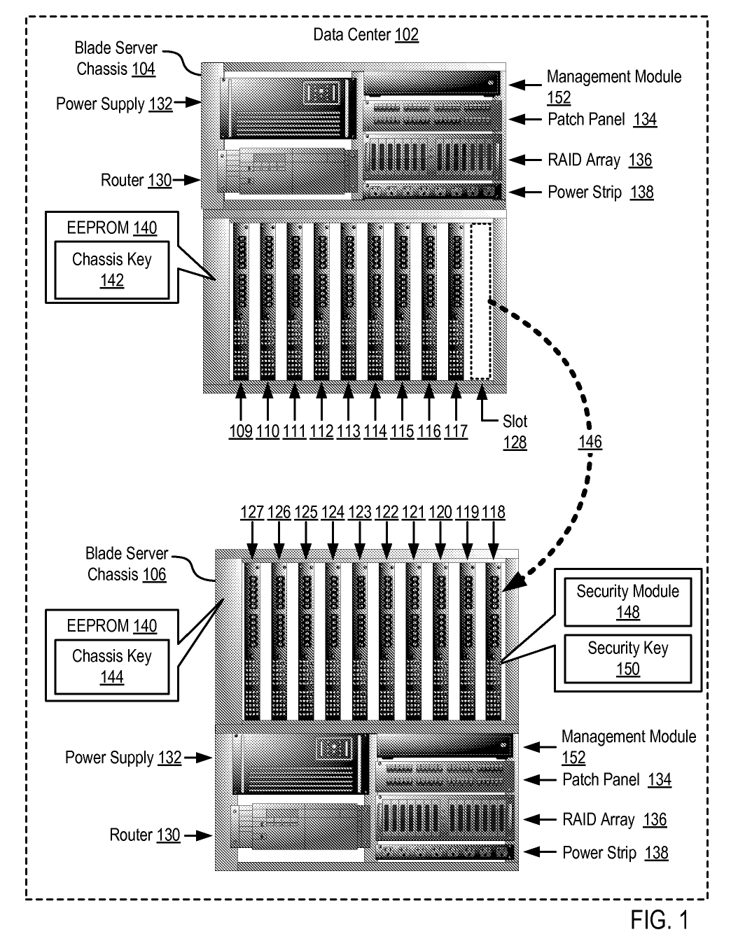

Exemplary methods, apparatus, and products for securing blade servers in a data center in accordance with the present invention are described with reference to the accompanying drawings, beginning with FIG. 1. FIG. 1 sets forth a functional block diagram of an exemplary implementing blade server security in a data center (102) according to embodiments of the present invention. The data center (102) is a facility used to house mission critical computer systems and associated components. Such a data center includes environmental controls (air conditioning, fire suppression, etc.), redundant/backup power supplies, redundant data communications connections, and high security, highlighted by biometric access controls to compartmentalized security zones within the facility. A data center is also used for housing a large amount of electronic equipment, typically computers and communications equipment. A data center is maintained by an organization for the purpose of handling the data necessary for its operations. A bank, for example, may have a data center, where all its customers' account information is maintained and transactions involving these accounts are carried out. Practically every company that is mid-sized or larger has some kind of data center with the larger companies often having dozens of data centers.

The data center (120) in the example of FIG. 1 includes two blade server chassis (104, 106) housing a number of blade servers. Blade servers (109-117) are installed in blade server chassis (104) and blade servers (118-127) are installed in blade server chassis (106). A blade server chassis is an enclosure in which blade servers as well as other electrical components are installed. The chassis provides cooling for servers, data communications networking connections, input/output device connections, power connections, and so on as will occur to those of skill in the art. One example blade server chassis is IBM's BladeCenter. An IBM BladeCenter E includes 14 blade slots, a shared media tray with an optical drive, floppy drive, and Universal Serial Bus (‘USB’) port, one or more management modules, two or more power supplies, two redundant high speed blowers, two slots for Gigabit Ethernet switches, and two slots for optional switch or pass-through modules such as Ethernet, Fibre Channel, InfiniBand or Myrient 2000 modules.

A server, as the term is used in this specification, refers generally to a multi-user computer that provides a service (e.g. database access, file transfer, remote access) or resources (e.g. file space) over a network connection. The term ‘server,’ as context requires, refers inclusively to the server's computer hardware as well as any server application software or operating system software running on the server. A server application is an application program that accepts connections in order to service requests from users by sending back responses. A server application can run on the same computer as the client application using it, or a server application can accept connections through a computer network. Examples of server applications include file server, database server, backup server, print server, mail server, web server, FTP servers, application servers, VPN servers, DHCP servers, DNS servers, WINS servers, logon servers, security servers, domain controllers, backup domain controllers, proxy servers, firewalls, and so on.

Blade servers are self-contained servers, designed for high density. As a practical matter, all computers are implemented with electrical components requiring power that produces heat. Components such as processors, memory, hard drives, power supplies, storage and network connections, keyboards, video components, a mouse, and so on, merely support the basic computing function, yet they all add bulk, heat, complexity, and moving parts that are more prone to failure than solid-state components. In the blade paradigm, most of these functions are removed from the blade computer, being either provided by the blade server chassis (DC power) virtualized (iSCSI storage, remote console over IP), or discarded entirely (serial ports). The blade itself becomes simpler, smaller, and amenable to dense installation with many blade servers in a single blade server chassis.

In addition to the blade servers (109-127), the blade server chassis (104, 106) in the example of FIG. 1 also house several other electrical components including a power supply (132), a data communications router (130, a patch panel (134) a RAID array (136), a power strip (138) and a management module (152).

A management module is an aggregation of computer hardware and software that is installed in a data center to provide support services for computing devices, such as blade servers. Support services provided by the management module (152) include monitoring health of computing devices and reporting health statistics to a system management server, power management and power control, save and restore configurations, discovery of available computing devices, event log management, memory management, and so on. An example of a management module that can be adapted for use in systems for securing blade servers according to embodiments of the present invention is IBM's Advanced Management Module (‘AMM’).

The management module (152) is connected for data communications to the blade servers and other computing devices through a local area network (‘LAN’). Such a LAN may be implemented as an Ethernet network, an IP (Internet Protocol) network, or the like. The management module is also connected to the blade servers through an out-of-band communications link. Such an out-of-band communications link may be implemented as an Inter-Integrated Circuit (‘I²C’) bus, a System Management Bus (‘SMBus’), an Intelligent Platform Management Bus (‘IPMB’), an RS-485 bus, or the like.

In the system of FIG. 1, each of the blade server chassis (104, 106) includes non-volatile memory in the form of Electrically Erasable Programmable Read-Only Memory (‘EEPROM’) (140). Stored in the EEPROM (140) of each chassis (104, 106) is a chassis key (142, 144). A chassis key is a value stored in non-volatile memory of a blade server chassis used to determine whether a blade server currently installed in the chassis is authorized for installation in the chassis. The chassis key may be implemented as a unique identification of the chassis—a chassis ID, a non-unique value that matches a number of other chassis keys, and in other ways as will occur to readers of skill in the art.

The management module (152) may retrieve such a chassis key (142, 144) from non-volatile memory of the chassis through an out-of-band communications link implemented in the mid-plane of the chassis. In many embodiments, the out-of-band communications link connecting the chassis to the management module is a different link than the out-of-band communications link connecting the blade servers to the management module for data communications. In one embodiment, for example, the out-of-band communications link connecting the blade servers to the management module is an RS-485 bus and the out-of-band communications link connecting the chassis to the management module is an I²C bus.

Each of the blade servers in the system of FIG. 1 includes a security module (148), a module of computer program that operates generally for securing blade servers in a data center according to embodiments of the present invention. Each of the blade servers may include a service processor that executes the security module (148) such as the Baseboard Management Controller (‘BMC’) found in many IBM blade servers.

The security module (148) in the example of FIG. 1 operates generally for securing blade servers in the data center (120) according to embodiments of the present invention by, upon receiving power in the blade server (118) installed in the blade server chassis (106) and prior to enabling user-level operation of the blade server, receiving, by the security module (148), from the management module (152), a chassis key (144) for the blade server chassis in which the blade server is installed. The blade server (118) may receive power upon a hot-plug of the blade server into a chassis, upon a user's powering-on the blade server once installed in the chassis, or in other ways as will occur to those of skill in the art.

In the example of FIG. 1, as illustrated by the dashed arrow (146), the blade server (118) has been removed from a blade server slot (128) in chassis (104) and installed, hot-plugged, in the blade server chassis (106). Upon powering-on a blade server, the management module (152) may be notified of the powered blade server by the blade server itself, by a power supply supplying power to the blade server, or in other ways as will occur to those of skill in the art. Responsive to such a notification, the management module (152) retrieves the chassis key (144) from EEPROM (140) of the blade server chassis and provides the chassis key (144) to the blade server (118) via an out-of-band communications link connecting the management module (152) and the blade server (118).

Upon powering-on, the blade server (118) enters a power-on self test (‘POST’) routine, which invokes the security module. That is, typical blade server POST routines may modified for securing blade servers according to embodiments of the present invention with the addition of the security module (148). The security module interrupts POST from continuing until the security module of the blade server receives a chassis key from the management module. Because POST is interrupted, user-level operations of the blade server are not executed. Examples of user-level operations include loading an operating system, establishing in-band data communications connections, executing user-level applications programs, and the like.

Although the security module (148) is described above as a component of a POST routine for a blade server, readers of skill in the art will immediately recognize, however, that security modules (148) for securing blade servers in a data center according to embodiments of the present invention may implemented in other ways, as a standalone firmware component that executes prior to any other computer program instructions upon a power-on of a blade server, as a component of a basic input/output services (‘BIOS’) module that is loaded during a POST routine and executes prior to boot-loading an operating system, and so on.

The security module may also determine whether the chassis key (144) matches a security key (150) stored on the blade server. If the chassis key (144) matches the security key (150), the security module (148) enables user-level operation of the blade server (118). Enabling user-level operation of the blade server may include enabling the blade server's POST routine to continue. If the chassis key (144) does not match the security key (150), the security module (148) disables operation of the blade server (118). In some embodiments of the present invention, prior to disabling operation of the blade server (118), the security module may notify the management module (152) that installation of the blade server (118) in the blade server chassis (106) is restricted.

A security key is a value that matches a chassis key of one or more blade server chassis for which installation of the blade server is authorized. A blade server configured according to embodiments of the present invention will not provide user-level operations when installed in a blade server chassis unless such chassis is an authorized chassis. That is a blade server executing a security module that operates for securing blade servers in accordance with the present invention and installed in an unauthorized blade server chassis is disabled. As mentioned above, the blade server (118) in the example of FIG. 1 is moved form a blade server slot (128) in blade server chassis (104) to the blade server chassis (106). If the blade server chassis (106) is a chassis for which installation of the blade servers (118) is unauthorized, that is, the chassis key (144) does not match the security key (150), the security module (148) of the blade server (118) will disable operation of the blade server. Methods of securing blade servers according to embodiments of the present invention effectively limit installation of blade servers to only those blade server chassis authorized for such installation. Said another way, blade servers are secured for installation to one or more specified blade server chassis.

The arrangement of servers, chassis, routers, power supplies, management modules, and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

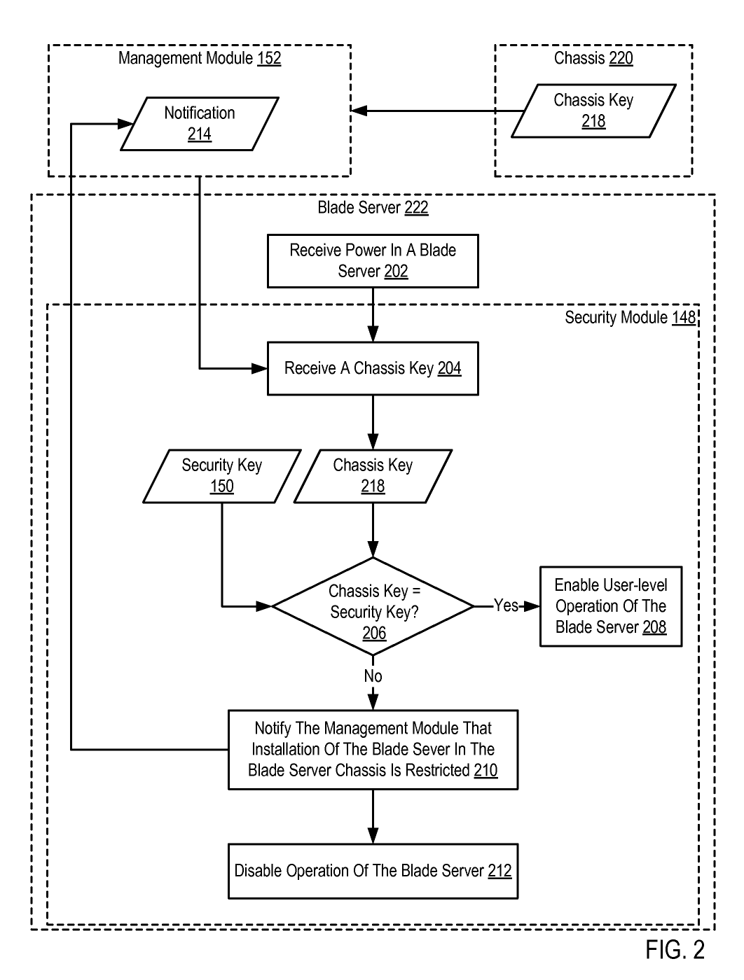

For further explanation, FIG. 2 sets forth a flow chart illustrating an exemplary method for securing blade servers in a data center according to embodiments of the present invention. The method of FIG. 2 may be implemented in a data center similar to the data center (102) illustrated in the system of FIG. 1 that includes a number of blade servers (108-127 on FIG. 1) with each blade server installed in one of a number of blade server chassis (220). The blade servers and the blade server chassis are connected for data communications to a management module (152). Each blade server chassis includes a chassis key (218) stored in non-volatile memory of the chassis, such as ROM (224).

Upon receiving (202) power in a blade server (222) installed in one of the blade server chassis (220) and prior to enabling (208) user-level operation of the blade server (222) the method of FIG. 2 includes, receiving (204), by a security module (148), from the management module (152), a chassis key (218) for the blade server chassis (220) in which the blade server (220) is installed. Receiving (202) power in a blade server (222) installed in one of the blade server chassis (220) may be carried out upon hot-plug of the blade server into a chassis slot, upon a user's power-on, upon a user's powering-on the blade server once installed in the chassis, or in other ways as will occur to readers of skill in the art.

Receiving (204), by a security module (148), from the management module (152), a chassis key (218) for the blade server chassis (220) in which the blade server (220) is installed may be carried out by receiving a value in a data communications message transmitted over an out-of-band communications link.

The method of FIG. 2 also includes determining (206), by the security module (148), whether the chassis key (218) matches a security key (150) stored on the blade server (222). Determining (206), by the security module (148), whether the chassis key (218) matches a security key (150) stored on the blade server (222) may be carried out by retrieving, by the security module (148), from non-volatile memory of the blade server (220) such as EEPROM connected to a service processor of the blade server, the security key and comparing the value of the security key to the value of the chassis key.

In some embodiments the chassis key may be an encrypted value. That is, a value stored in non-volatile memory may be encrypted according to a public key or symmetric algorithm encryption technique. In such embodiments, determining (206) whether the chassis key (218) matches a security key (150) stored on the blade server (222) may also include decrypting the encrypted value.

If the chassis key (218) matches the security key (150), the method of FIG. 2 continues by enabling (208), by the security module (148), user-level operation of the blade server. Enabling (208), by the security module (148), user-level operation of the blade server may include enabling the completion of a POST routine, boot-loading an operating system, executing one or more user-level computer application programs such as a web server application program, enabling I/O adapters for user-interface devices, and the like.

If the chassis key (204) does not match the security key (150), the method of FIG. 2 continues by notifying (210) the management module (152), by the security module (148), that installation of the blade server (222) in the blade server chassis (220) is restricted and disabling (212), by the security module (148), operation of the blade server (222). Notifying (210) the management module (152) that installation of the blade server (222) in the blade server chassis (220) is restricted may be carried out by sending a data communications message containing the notification to the management module through an out-of-band communications link connected for data communications to the service processor, the BMC, of blade server (222). With this notification, the management module is made aware of the reason for the apparent failure of the blade server (222) and may, in turn, notify a system administrator of the restricted installation of the blade server.

Disabling (212), by the security module (148), operation of the blade server (222) may include powering-off the blade server. Disabling (212) operation of the blade server (222) may also include setting a flag prior to powering-off the blade server which indicates to a security module upon a subsequent power-on, that operations should be disabled immediately without determining whether installation in the blade server chassis is restricted. In this way, even if a disabled blade server is subsequently installed in an authorized or unrestricted blade server chassis, the blade server remains disabled. Such a flag may be removed by a system administrator by accessing blade server EEPROM through an out-of-band communications link between the management module and the blade server.

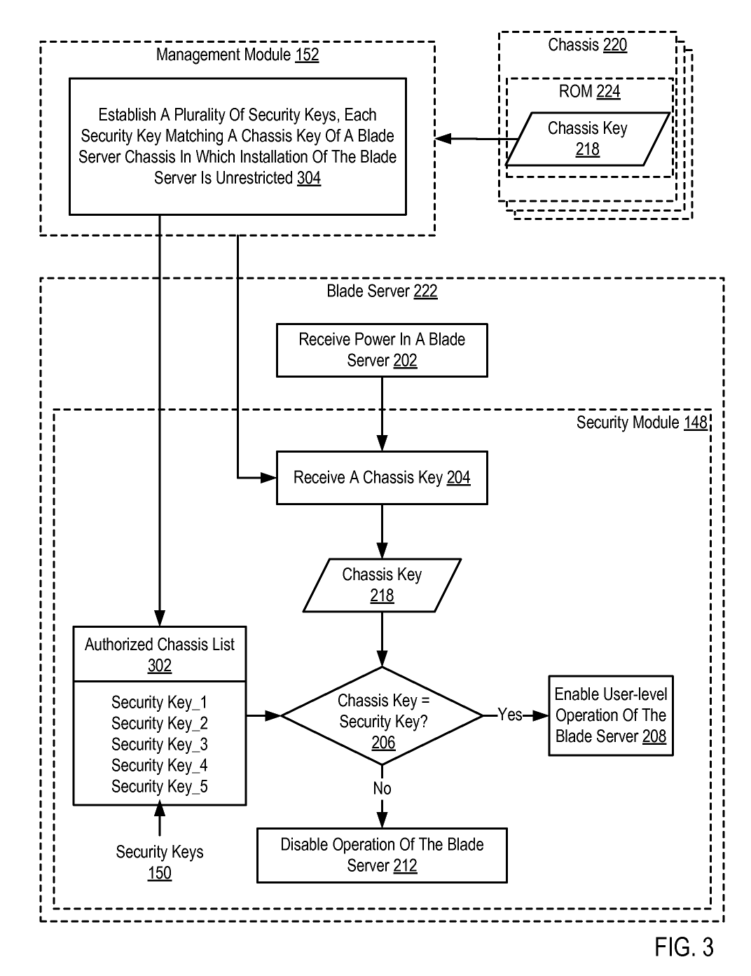

For further explanation, FIG. 3 sets forth a flow chart illustrating a further exemplary method for securing blade servers in a data center according to embodiments of the present invention. The method of FIG. 3 is similar to the method of FIG. 2 in that the method of FIG. 3 may also be implemented in a data center similar to the data center (102) illustrated in the system of FIG. 1 that includes a number of blade servers (108-127 on FIG. 1) with each blade server installed in one of a number of blade server chassis (220). The blade servers and the blade server chassis may be connected for data communications to a management module (152) and each blade server chassis may include a chassis key (218) stored in non-volatile memory.

The method of FIG. 3 is also similar to the method of FIG. 2, including, as it does, the security module's (148) receiving (204), from the management module (152), a chassis key (218) for the blade server chassis (220) in which the blade server (222) is installed; determining (206) whether the chassis key (218) matches a security key (150) stored on the blade server (222); enabling (208) user-level operation of the blade server if the chassis key (218) matches the security key (150); and disabling operation of the blade server (222) if the chassis key (218) does not match the security key (150).

The method of FIG. 3 differs from the method of FIG. 2, however, in that the method of FIG. 3 includes establishing (304) a plurality of security keys (150) in the blade server (222). Each security key (150) in the example of FIG. 3 matches a chassis key (218) of a blade server chassis in which installation of the blade server is unrestricted. Establishing (304) a plurality of security keys (150) in the blade server (222) may be carried out by the management module at the behest of a system administrator by storing, in a data structure such a list (302) for example, a value of each chassis key for each of a plurality of authorized blade server chassis. In the example of FIG. 3, five security keys, each key matching a chassis key of an authorized blade server chassis, are established in authorized chassis list (302).

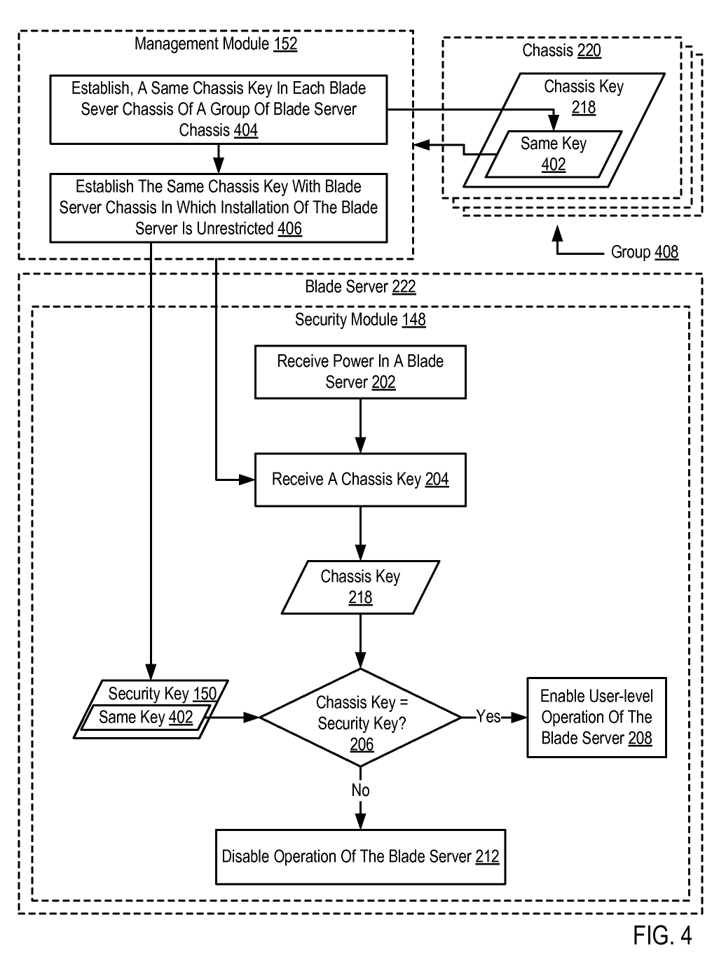

For further explanation, FIG. 4 sets forth a flow chart illustrating a further exemplary method for securing blade servers in a data center according to embodiments of the present invention. The method of FIG. 4 is similar to the method of FIG. 2 in that the method of FIG. 4 may also be implemented in a data center similar to the data center (102) illustrated in the system of FIG. 1 that includes a number of blade servers (108-127 on FIG. 1) with each blade server installed in one of a number of blade server chassis (220). The blade servers and the blade server chassis may be connected for data communications to a management module (152) and each blade server chassis may include a chassis key (218) stored in non-volatile memory.

The method of FIG. 4 is also similar to the method of FIG. 2, including, as it does, the security module's (148) receiving (204), from the management module (152), a chassis key (218) for the blade server chassis (220) in which the blade server (222) is installed; determining (206) whether the chassis key (218) matches a security key (150) stored on the blade server (222); enabling (208) user-level operation of the blade server if the chassis key (218) matches the security key (150); and disabling operation of the blade server (222) if the chassis key (218) does not match the security key (150).

The method of FIG. 4 differs from the method of FIG. 2, however, in that the method of FIG. 4 includes establishing (404), by the management module (152), a same chassis key (402) in each blade server chassis (202) of a group (408) of blade server chassis (220). A ‘same chassis key’ in the method of FIG. 4 refers to the fact that the chassis key stored in non-volatile memory of each blade server in the group of blade servers is the same value. Establishing (404) a same chassis key (402) in each blade server chassis (202) of a group (408) of blade server chassis (220) may be carried out at the behest of a system administrator through an out-of-band communications link by storing, as a chassis key in non-volatile memory of each chassis of the group of chassis, the same, that is a matching, value.

In this way a blade server may be configured with a single security key that enables installation into a group of authorized blade server chassis. Information technology system administrators may organize blade server assets according to business units in an organization. Consider, for example, an organization that includes a marketing business unit, sales business unit, and an customer support business unit where each of the business units are allocated a particular group of a blade server chassis. By restricting blade servers to installation in such chassis, system administrators may restrict blade servers to particular business units.

The method of FIG. 4 also includes establishing (406), by the management module (152) as the security key (150) in the blade server, the same chassis key (402) of blade server chassis in which installation of the blade server is unrestricted. Establishing (406), by the management module (152) as the security key (150) in the blade server, the same chassis key (402) of blade server chassis in which installation of the blade server is unrestricted may be carried out at the behest of a system administrator through a user-interface provided by the management module (1 52). Establishing (406) such a security key (150) in the blade server may include storing the key in non-volatile memory of the blade server through an out-of-band communications link connecting the blade server and the management module. Another way to establish a security key in a blade server, not through use of the management module, may be through the blade server's BIOS firmware, directly accessible through user input/output (‘I/O’) devices by a user with administrator-level access permissions.

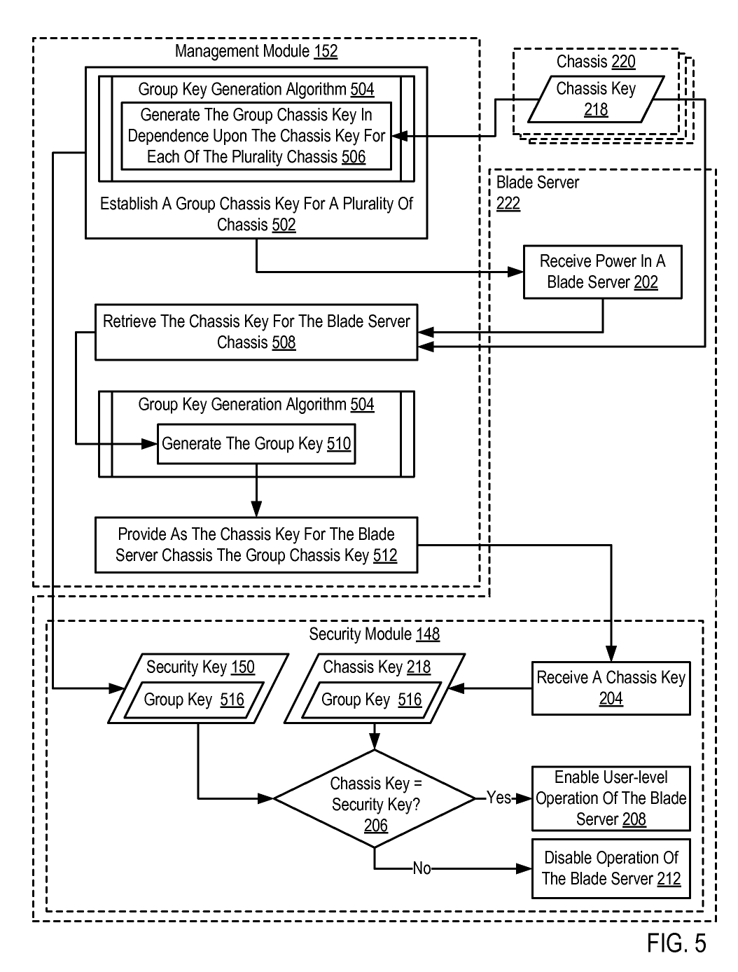

For further explanation, FIG. 5 sets forth a flow chart illustrating a further exemplary method for securing blade servers in a data center according to embodiments of the present invention. The method of FIG. 5 is similar to the method of FIG. 2 in that the method of FIG. 5 may also be implemented in a data center similar to the data center (102) illustrated in the system of FIG. 1 that includes a number of blade servers (108-127 on FIG. 1) with each blade server installed in one of a number of blade server chassis (220). The blade servers and the blade server chassis may be connected for data communications to a management module (152) and each blade server chassis may include a chassis key (218) stored in non-volatile memory.

The method of FIG. 5 is also similar to the method of FIG. 2, including, as it does, the security module's (148) receiving (204), from the management module (152), a chassis key (218) for the blade server chassis (220) in which the blade server (222) is installed; determining (206) whether the chassis key (218) matches a security key (150) stored on the blade server (222); enabling (208) user-level operation of the blade server if the chassis key (218) matches the security key (150); and disabling operation of the blade server (222) if the chassis key (218) does not match the security key (150).

The method of FIG. 5 differs from the method of FIG. 2, however, the method of FIG. 5 includes establishing (502), by the management module (152) as the security key (150) stored in the blade server (222), a group chassis key (516) for a plurality of chassis (220). In the method of FIG. 5, establishing (502), by the management module (152) as the security key (150) stored in the blade server (222), a group chassis key (516) for a plurality of chassis (220) includes generating (506) the group chassis key (516) in dependence upon the chassis key (218) for each of the plurality chassis (220) through a group key generation algorithm (504).

A group key established in a blade server is a value that matches keys provided by the management module to the blade server as chassis keys of a number of authorized blade server chassis. While the value stored in non-volatile memory of any authorized blade server chassis may not, in fact, match the value of the key stored in the blade server, the group key generation algorithm is capable of generating a matching value in dependence the values stored in the blade server chassis.

A group key generation algorithm (504) is module of computer program instructions that generates a single key in dependence upon the values of a plurality of keys. Once that single key is generated, the same key may be later generated in dependence upon only one of the plurality of keys. That is, the group key generation algorithm is also configured to generate that same single key in dependence upon any one of the plurality of keys.

The method of FIG. 5 also includes retrieving (508), by the management module (152), from non-volatile memory of the blade server chassis (220) in which the blade server is installed, the chassis key (218) for the blade server chassis (220). Retrieving (508) the chassis key (218) for the blade server chassis (220) may be carried out through an out-of-band communications link between the management module (152) and the blade server chassis.

The method of FIG. 5 also includes generating (510), by the management module (152) in dependence upon the retrieved chassis key (218), the group key (516). Generating (510) the group key (516) in dependence upon the retrieved chassis key (218) may be carried out by executing the group key generation algorithm (504), using as input to the algorithm, the chassis key.

The method of FIG. 5 also includes providing (512), by the management module, to the blade server (222) as the chassis key (218) for the blade server, the group chassis key (516). Providing (512), the group chassis key (516) to the blade server (222) as the chassis key (218) for the blade server chassis may be carried out by providing the value generated by the group key generation algorithm (504) to the blade server via an out-of-band communications link.

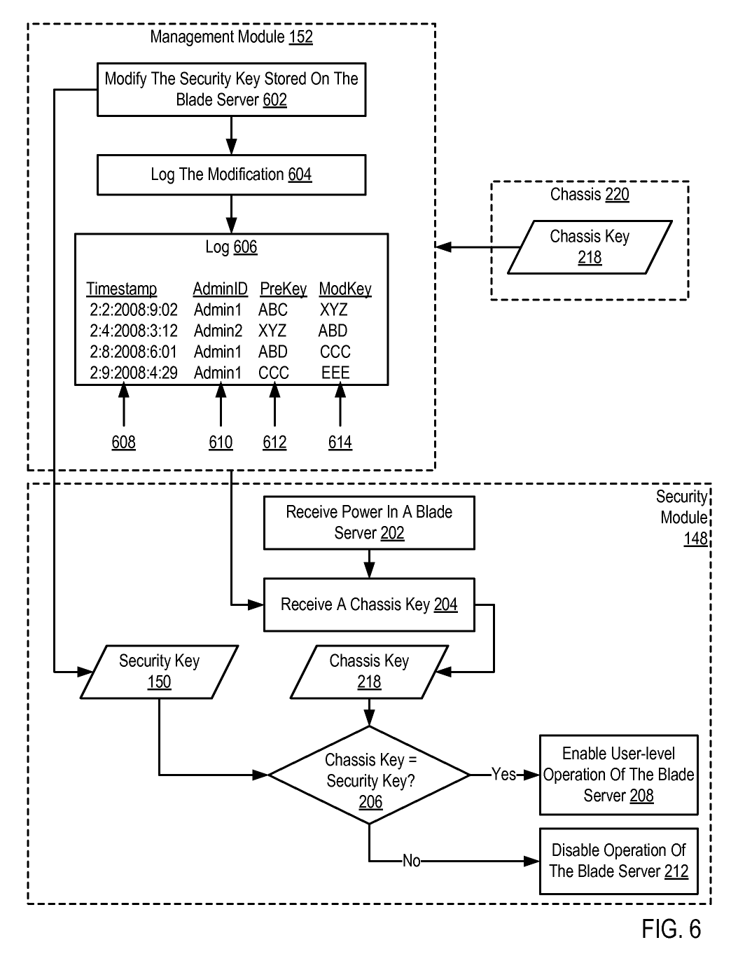

For further explanation, FIG. 6 sets forth a flow chart illustrating a further exemplary method for securing blade servers in a data center according to embodiments of the present invention. The method of FIG. 6 is similar to the method of FIG. 2 in that the method of FIG. 6 may also be implemented in a data center similar to the data center (102) illustrated in the system of FIG. 1 that includes a number of blade servers (108-127 on FIG. 1) with each blade server installed in one of a number of blade server chassis (220). The blade servers and the blade server chassis may be connected for data communications to a management module (152) and each blade server chassis may include a chassis key (218) stored in non-volatile memory.

The method of FIG. 6 is also similar to the method of FIG. 2, including, as it does, the security module's (148) receiving (204), from the management module (152), a chassis key (218) for the blade server chassis (220) in which the blade server (222) is installed; determining (206) whether the chassis key (218) matches a security key (150) stored on the blade server (222); enabling (208) user-level operation of the blade server if the chassis key (218) matches the security key (150); and disabling operation of the blade server (222) if the chassis key (218) does not match the security key (150).

The method of FIG. 6 differs from the method of FIG. 2 however in that method of FIG. 6 includes modifying (602), by the management module (152) through an out-of-band communications link, the security key (150) stored on the blade server (222) and logging (604), by the management module (152), the modification (602).

Modifying (602) the security key (150) stored on the blade server (222) may be carried out at the behest of a user with administrator-level access permission through a manipulation of a graphical user interface provided to the user by the management module and user inputs through user input devices such as a keyboard and mouse.

Logging (604), by the management module (152), the modification (602) may include storing in a record of a log (606) a timestamp (608), an identification of the user (610) causing the modification, a value (612) of the security key prior to modification, and a value (614) of the security key after the modification. In this way, system administrators may ‘check-out’ and ‘check-in’ a blade server from and to blade server chassis by modifying the security key of the blade server. The log (606) then shows an historical record of modifications.

Exemplary embodiments of the present invention are described largely in the context of a fully functional computer system for securing blade servers in a data center. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of securing blade servers in a data center, the data center comprising a plurality of blade servers, each blade server installed in one of a plurality of blade server chassis, the blade servers and the blade server chassis connected for data communications to a management module, each blade server chassis comprising a chassis key stored in non-volatile memory of the chassis, the method comprising:
upon receiving power in a blade server installed in one of the blade server chassis and prior to enabling user-level operation of the blade server, receiving, by a security module, from the management module, a chassis key for the blade server chassis in which the blade server is installed;
determining, by the security module, whether the chassis key matches a security key stored on the blade server;
if the chassis key matches the security key, enabling, by the security module, user-level operation of the blade server; and
if the chassis key does not match the security key, disabling, by the security module, operation of the blade server.

2. The method of claim 1 further comprising:
if the chassis key does not match the security key, notifying the management module, by the security module, that installation of the blade server in the blade server chassis is restricted.

3. The method of claim 1 further comprising:
establishing a plurality of security keys in the blade server, each security key matching a chassis key of a blade server chassis in which installation of the blade server is unrestricted.

4. The method of claim 1 further comprising:
establishing, by the management module, a same chassis key in each blade server chassis of a group of blade server chassis; and
establishing, by the management module as the security key in the blade server, the same chassis key of blade server chassis in which installation of the blade server is unrestricted.

5. The method of claim 1 further comprising:
establishing, by the management module as the security key stored in the blade server, a group chassis key for a plurality of chassis, including generating the group chassis key in dependence upon the chassis key for each of the plurality chassis through a group key generation algorithm;
retrieving, by the management module, from non-volatile memory of the blade server chassis in which the blade server is installed, the chassis key for the blade server chassis;
generating, by the management module in dependence upon the retrieved chassis key, the group key; and
providing, by the management module, to the blade server as the chassis key for the blade server chassis, the group chassis key.

6. The method of claim 1 further comprising:
modifying, by the management module through an out-of-band communications link, the security key stored on the blade server; and
logging, by the management module, the modification.

7. An apparatus for securing blade servers in a data center, the data center comprising a plurality of blade servers, each blade server installed in one of a plurality of blade server chassis, the blade servers and the blade server chassis connected for data communications to a management module, each blade server chassis comprising a chassis key stored in non-volatile memory of the chassis, the apparatus comprising a computer processor, a computer memory operatively coupled to the computer processor, the computer memory having disposed within it computer program instructions capable of:
upon receiving power in a blade server installed in one of the blade server chassis and prior to enabling user-level operation of the blade server, receiving, by a security module, from the management module, a chassis key for the blade server chassis in which the blade server is installed;
determining, by the security module, whether the chassis key matches a security key stored on the blade server;
if the chassis key matches the security key, enabling, by the security module, user-level operation of the blade server; and
if the chassis key does not match the security key, disabling, by the security module, operation of the blade server.

8. The apparatus of claim 7 further comprising computer program instructions capable of:
if the chassis key does not match the security key, notifying the management module, by the security module, that installation of the blade server in the blade server chassis is restricted.

9. The apparatus of claim 7 further comprising computer program instructions capable of:
establishing a plurality of security keys in the blade server, each security key matching a chassis key of a blade server chassis in which installation of the blade server is unrestricted.

10. The apparatus of claim 7 further comprising computer program instructions capable of:
establishing, by the management module, a same chassis key in each blade server chassis of a group of blade server chassis; and
establishing, by the management module as the security key in the blade server, the same chassis key of blade server chassis in which installation of the blade server is unrestricted.

11. The apparatus of claim 7 further comprising computer program instructions capable of:
establishing, by the management module as the security key stored in the blade server, a group chassis key for a plurality of chassis, including generating the group chassis key in dependence upon the chassis key for each of the plurality chassis through a group key generation algorithm;
retrieving, by the management module, from non-volatile memory of the blade server chassis in which the blade server is installed, the chassis key for the blade server chassis;
generating, by the management module in dependence upon the retrieved chassis key, the group key; and
providing, by the management module, to the blade server as the chassis key for the blade server chassis, the group chassis key.

12. The apparatus of claim 7 further comprising computer program instructions capable of:
modifying, by the management module through an out-of-band communications link, the security key stored on the blade server; and
logging, by the management module, the modification.

13. A computer program product for securing blade servers in a data center, the data center comprising a plurality of blade servers, each blade server installed in one of a plurality of blade server chassis, the blade servers and the blade server chassis connected for data communications to a management module, each blade server chassis comprising a chassis key stored in non-volatile memory of the chassis, the computer program product disposed in a computer readable, signal bearing medium, the computer program product comprising computer program instructions capable of:
upon receiving power in a blade server installed in one of the blade server chassis and prior to enabling user-level operation of the blade server, receiving, by a security module, from the management module, a chassis key for the blade server chassis in which the blade server is installed;
determining, by the security module, whether the chassis key matches a security key stored on the blade server;
if the chassis key matches the security key, enabling, by the security module, user-level operation of the blade server; and
if the chassis key does not match the security key, disabling, by the security module, operation of the blade server.

14. The computer program product of claim 13 further comprising computer program instructions capable of:
if the chassis key does not match the security key, notifying the management module, by the security module, that installation of the blade server in the blade server chassis is restricted.

15. The computer program product of claim 13 further comprising computer program instructions capable of:
establishing a plurality of security keys in the blade server, each security key matching a chassis key of a blade server chassis in which installation of the blade server is unrestricted.

16. The computer program product of claim 13 further comprising computer program instructions capable of:
establishing, by the management module, a same chassis key in each blade server chassis of a group of blade server chassis; and
establishing, by the management module as the security key in the blade server, the same chassis key of blade server chassis in which installation of the blade server is unrestricted.

17. The computer program product of claim 13 further comprising computer program instructions capable of:
establishing, by the management module as the security key stored in the blade server, a group chassis key for a plurality of chassis, including generating the group chassis key in dependence upon the chassis key for each of the plurality chassis through a group key generation algorithm;
retrieving, by the management module, from non-volatile memory of the blade server chassis in which the blade server is installed, the chassis key for the blade server chassis;
generating, by the management module in dependence upon the retrieved chassis key, the group key; and
providing, by the management module, to the blade server as the chassis key for the blade server chassis, the group chassis key.

18. The computer program product of claim 13 further comprising computer program instructions capable of:
modifying, by the management module through an out-of-band communications link, the security key stored on the blade server; and
logging, by the management module, the modification.

19. The computer program product of claim 13 wherein the signal bearing medium comprises a recordable medium.

20. The computer program product of claim 13 wherein the signal bearing medium comprises a transmission medium.
